(19) United States
(12) Patent Application Publication
(10) Pub. No.: US 2018/0065433 A1
(43) Pub. Date: Mar. 8, 2018

(54) DUAL-MODE, ADJUSTABLE-SPAN VEHICLES (DMASV) AND A RAIL FREEWAY SYSTEM

(71) Applicants: Joey H. Sun, Katy, TX (US); Haiwang T. Sun, Katy, TX (US); Tianjin Sun, Katy, TX (US)

(72) Inventors: Joey H. Sun, Katy, TX (US); Haiwang T. Sun, Katy, TX (US); Tianjin Sun, Katy, TX (US)

(21) Appl. No.: 15/696,165

(22) Filed: Sep. 5, 2017

Related U.S. Application Data
(60) Provisional application No. 62/383,427, filed on Sep. 3, 2016.

(51) Int. Cl. B60F 1/04; E01B 25/28; E01B 26/00; B60M 7/00

(52) U.S. Cl. CPC B60F 1/04; E01B 25/28; H04L 67/12; B60M 7/00; E01B 26/00

(57) ABSTRACT

A dual-mode, adjustable wheel-span vehicle includes at least two pairs of rail wheels for use on rails, wherein some or all of the at least two pairs of rail wheels are adjustable in a distance between a pair of the rail wheels such that the at least two pairs of rail wheels can work with different rail gauges; a mechanism for adjusting a span of the at least two pairs of rail wheels; and at least two pairs of tire wheels for regular roadways. A transportation system for the vehicles includes a rail freeway network having electric power supply lines, sensors to get local information, signals to show system status, and a central computer for system controls; and a plurality of entry and exit ramps for the vehicles to enter or exit the rail freeway network, wherein the entry and exit ramps includes an overhead and/or underneath ramp.

### CROSS REFERENCE TO RELATED APPLICATIONS

This claims the benefits of Provisional Application No. 62/383,427, filed on Sep. 3, 2016, the disclosure of which is incorporated by reference in its entirety.

### FIELD OF INVENTION

This invention relates to dual-mode vehicles of adjustable wheel spans and a rail freeway system using the same.

### BACKGROUND OF THIS INVENTION

As the populations of many big cities in the world grow bigger, their metropolitan areas become larger and the commutes within the cities and transportation between them become more congested.

Traffic congestion has been one of the biggest headaches for both developing and developed countries. Traffic congestion is an economical issue, as it causes more gas burning, car wearing and money loss. In this sense, it is also an environmental issue, as more gas burning leads to more air pollution. On the other hand, as people spending more and more time on the roads, breathing dirty air, traffic congestion becomes a health issue for individuals and a production efficiency issue for companies and countries, since exhausted workers in polluted air are more easily to get sick and have low work efficiency. Further related with these issues is a safety issue, as exhausted drivers are likely to get involved with car accidents. In short, traffic congestion has been one of the main obstacles for the economy growth of many countries.

Complaints on traffic congestion are growing in almost all big cities in the world. Although people have been using many methods to fight with the problem, they are losing the hope to win the battle. Methods like subways, carpools, buses, and metro light rails all have their own limitation and could not be used to solve the problem.

One common method for the problem is road remodeling and widening. However, highway widening may not be the wise solution to traffic congestion problems in big cities. Building new highways in big cities is neither wise nor practical.

There are 3 types of mass inter-city transportation systems besides car driving: trains, buses, and airplanes. All these travel types take the model of “car+mass transit+car.” In other words, people use car to go to the mass transit starting points such as airports or bus/train stations, take the mass transporting vehicles to the mass transit ending points, then take cars to go to their destinations. Another mass transportation system, the high-speed bullet train system, has been quite successful in many countries, such as China, Japan, France, Germany, South Korea, Spain, Russia, and so on. A study conducted by the International Union of Railways indicated that high-speed trains produced five times less CO₂ than automobiles and jet aircraft. Many people in the US are calling for building such bullet train systems in the U.S.

Americans may not see a vast construction of bullet train systems. However, the demands for an effective mass transportation system still exist. Some people believe the Hyperloop and self-driving cars will be the American future. Unfortunately, both systems are still at their premature stages and bear doubts for their possibilities and profits.

Several different kinds of dual-mode vehicles and the transportation systems have been proposed in the past, but none of them allows incessant accesses, thus are not practical.

U.S. Pat. No. 6,039,135 describes an electrically powered vehicle transportation system which utilized a guideway with parallel rails. The dual-mode vehicles used regular tires. These vehicles are called dual-mode simply because the same set of tires can run on the hard-surface rails as well on regular roadways. The wheel spans are extendable to fit the pair of parallel rails. Since this transportation system used the regular tires, the system cannot be used to improve the energy efficiency.

U.S. Pat. No. 6,523,480 describes another dual-mode transportation system. The system has a triangle-shaped monorail. A set of rubber tire wheels was designed to run on the monorail. Another set of rubber tires could be used to run on regular roadways. The railways were sectioned for the vehicles to get on or off the monorail. Because of the sectioned railways and the rubber tires running on them, the system cannot be used to achieve the speeds and energy efficiency as high as the bullet trains.

U.S. Pat. No. 9,037,388 proposes an intelligent public transit system using dual-mode vehicles. The vehicles, although being called dual-mode, were actually using one set of rubber tires for both regular roadways and controlled roadways with raised contact surfaces. No rails were applied. The patent documented a range of complex sensors and controlling mechanisms that were used to guide the vehicles to enter or exit the controlled roadways. Because the vehicle used the regular tires in the controlled roadways, it's hard for the system to reach a speed as high as nowadays bullet trains. Because of the way that entering vehicles merged with the passing vehicles, the control became extremely complex.

U.S. Pat. No. 4,981,083 discloses a dual-mode semi-trailer which used rubber tired wheels for running on roadways. When attempting to run on rails, the flanged rail wheel bogie can be mounted. The mounting and demounting operations take time and cannot be used for modern transportation.

U.S. Pat. No. 6,324,994 describes a hybrid transit system which includes vehicles with dual-mode wheels with rubber tires and rail rims and alternative sectional roadway and railway. The sections of roadway are for the vehicles to get out of the railways. Obviously, the system with this kind of design cannot be used for high-speed travels.

CN Patent No. 201849271 proposes a system similar to the one described by U.S. Pat. No. 6,324,994. The differences are the newly proposed vehicle has different power transmission system. It also proposed a rail shifting mechanism that can be adjusted to one position for passing vehicles and another position for exiting vehicles. Because of the rail shifting, it is hard for the system to be used for high-speed travels such as the bullet trains.

The above reviews showed that the existing proposals were either using regular tire wheels for guideways or railways or using rail wheels on sectional rail tracks, which limited the system speed. These systems cannot meet the demands of nowadays high-speed transportation. Therefore, there is still a need for a better high-speed transportation system.

### SUMMARY OF INVENTION

Traffic jams have been acting like artery clogs for most modern cities. This problem has led to more and more time waste, energy consuming, and air pollution. All these further increase people's stress, deteriorate people's health, and lower people's work efficiency. Driving to work under high stresses often causes more accidents on the roads. As the bullet train systems have been proven to be a big success in China, calls for a similar system in the U.S. are growing. Due to people's habit of private driving and air traveling in countries like the U.S., Canada, Australia, and so on, it is concerned that the bullet train mass transportation may not be economical in these countries. Three states in the US rejected the bullet train idea and even turned down the fund for initial evaluation.

Embodiments of this invention provide a totally new transportation system that can be built at the spare spaces alongside the freeways. With the stereo (3D) designs of entryways and exits, the new system is expected to significantly ease the freeways' traffic load and drastically reduce the time needed for inner-city commutes and inter-city travels, because it can act like metro freeways for daily commutes and bullet trains for inter-city travels.

Embodiments of the invention relate to a new transportation system, which uses a new kind of dual-mode, adjustable-span vehicles, simplified as DMAS vehicles or DMASV's. These vehicles have the common features of rubber-tire wheels and steel-rail wheels adaptable for roadways and railways, respectively. Their uniqueness, which is one of the core ideas for this invention, is that the spans of part or all their rail-wheels can be controlled to expand or shrink. These actions allow the vehicles to get on or off the railways freely using the suitable rail wheels on the correct rails. Based on the practical needs, at least two pairs of rail wheels have to have adjustable spans. For the sake of strength, some of the wheel pairs can have fixed wheel spans. By changing the type and location of the adjustable rail wheels on the vehicle, many different kinds of DMASV can be designed. However, the core spirit and scope of this invention, that is, the adjustability of rail wheel spans, should not be changed.

The span of a rail wheel pair can be changed using many methods. These methods include, but not limited to, mechanical, hydraulic, pneumatic, magnetic ways. This description will present examples based on a mechanical method. However, these examples are for illustration only and one skilled in the art would appreciate that other suitable methods can be used without departing from the scope of the invention.

One aspect of the invention relates to dual-mode, adjustable wheel-span vehicles. A dual-mode, adjustable wheel-span vehicle, in accordance with one embodiment of the invention, includes at least two pairs of rail wheels for use on rails, wherein some or all of the at least two pairs of rail wheels are adjustable in a distance between a pair of the rail wheels such that the at least two pairs of rail wheels can work with different rail gauges; a mechanism for adjusting a span of the at least two pairs of rail wheels; and at least two pairs of tire wheels for regular roadways.

Another aspect of the invention relates to a transportation system for the above vehicles. A transportation system in accordance with one embodiment of the invention includes a rail freeway network having electric power supply lines, sensors to get local information, signals to show system status, and a central computer for system controls; and a plurality of entry and exit ramps for the vehicles to enter or exit the rail freeway network, wherein the entry and exit ramps includes an overhead and/or underneath ramp.

Another innovative feature for this invention is the special design of entry and exit ramps for rail freeways. Rail freeways are railways that allow individual or group vehicles to enter or exit the main railways freely without affecting other vehicles going through the sections of the main railway at the entryways or exits. They function like the regular freeways.

Embodiments of this invention use two types of ramp structures. Both types of structures have two pairs of rail tracks, called inner pair and outer pair, at the entryways and exits. The first type is designed to let the DMFSV enter from and exit to ramps that are attached to a platform above the main rails. The second type of rail structures is designed to allow the DMASV entering and exiting from below the main rails.

To save space on the railways, these DMASV can be chained up like a train. If the traffic becomes heavy, multiple lanes can be built and lane shifting can be done using structures similar to these overhead and underneath ramps.

Two sets of brakes are needed for these DMASV's—one for the rubber tire wheels and the other for the rail wheels. The ones for rail wheels have to meet two functions—to slow down the vehicle and to hold the vehicles on rails, especially at the ramp sections when braking.

Modern technologies of sensing, computing, logic analysis and control are also fundamental to this invention. After entering and before exiting the rail system, the vehicles should be fully controllable by system computers together with the computers on the vehicles. This auto control mode frees the drivers, allowing them to work, to sleep, to entertain, to talk with others over the phones, or even to play with their babies.

In general, this invention has many advantages and is a very practical invention.

### BRIEF DESCRIPTION OF THE DRAWINGS

FIG. 1 shows a first type of dual-mode, adjustable-span vehicles (Type A) in accordance with embodiments of the invention. Both pairs of adjustable rail wheels are independent of the tire wheels. (a) Side view; (b) Top view, adjustable wheels contracted; (c) Top view, adjustable wheels extended.

FIG. 2 shows a second type of dual-mode, adjustable-span vehicles (Type B) in accordance with embodiments of the invention. One pair of adjustable rail wheels is independent of the tire wheels, while the other pair is built with the rear tire wheels. (a) Side view; (b) Top view, adjustable wheels contracted; (c) Top view, adjustable wheels extended.

FIG. 3 shows a third type of dual-mode, adjustable-span vehicles (Type C) in accordance with embodiments of the invention. Both pairs of adjustable rail wheels are inserted into the tire wheels. (a) Side view; (b) Top view, adjustable wheels contracted; (c) Top view, adjustable wheels extended.

FIG. 4 shows a fourth type of dual-mode, adjustable-span vehicles (Type D) in accordance with embodiments of the invention. They are similar to Type A vehicles except the body shape. This type is good for transporting more passengers in one vehicle.

FIG. 5 shows a fifth type of dual-mode, adjustable-span vehicles (Type E) in accordance with embodiments of the invention. They are similar to Type D vehicles except that the two pairs of adjustable rail wheels are located at the top of the vehicles.

FIG. 6 shows a first type of mono-mode, adjustable-span vehicles or adjustable-span bus on rails (Type F) in accordance with embodiments of the invention. They are useful for non-stop passenger loading and unloading of bullet trains.

FIG. 7 shows a second type of mono-mode, adjustable-span vehicles or adjustable-span bus on rails (Type G) in accordance with embodiments of the invention. They are also useful for non-stop passenger loading and unloading of bullet trains.

FIG. 8 shows an overhead entrance ramp (a) and exit ramp (b) in accordance with embodiments of the invention. The inner rails are continuous and used for through vehicles. The through or long-distance traveling vehicles use their rail wheels with least span. This is mechanically favorable for adjustable-span vehicles on long-distance trips.

FIG. 9 shows an underneath exit ramp in accordance with embodiments of the invention. The inner rails are sectioned for entering vehicles. The rails for passing vehicles must be the outer rails, therefore, the vehicles must run with their adjustable wheels at the larger span at every ramp. This needs stronger vehicles. This type of ramps is useful for inner-city daily commutes where the main rails have to be elevated for highway entering and exiting.

FIG. 10 shows considerations on ground-to-rail and rail-to-ground transitions in accordance with embodiments of the invention.

FIG. 11 shows a mechanism for concurrent expansion and retraction of adjustable rail wheels in accordance with embodiments of the invention. (a) The vehicle is at its retracted state.

FIG. 12 shows rail design options in relation with entrance and exit ramps in accordance with embodiments of the invention.

FIG. 13 shows layouts to show the rail-wheel relations at the weak points (a) and strong points (b) in accordance with embodiments of the invention. FIG. 13(a) shows a Type C vehicle on outer rails—the weak case at cross-sections marked by A-A′, B-B′, and C-C′ as shown in FIGS. 12 (a) and (b-1). FIG. 13(b) shows Type A vehicle on both outer rails and inner rails—the strong case at cross-section marked by D-D′ as shown in FIG. 12 (b-2).

FIG. 14 shows modified overhead ramps in accordance with embodiments of the invention.

FIG. 15 shows a vehicle and wire hook-up device in accordance with embodiments of the invention.

FIG. 16 shows a passenger loading and unloading system for non-stop bullet trains in accordance with embodiments of the invention.

FIG. 17 shows a passenger loading and unloading system for non-stop bullet trains by combining overhead entrance ramp FIG. 8 (a) and overhead exit ramp FIG. 8 (b) in accordance with embodiments of the invention. The self-powered bus on rails are shown in FIG. 6.

FIG. 18 shows an entry ramp with elevated ramp rails for vehicle Type E in accordance with embodiments of the invention.

### DETAILED DESCRIPTION OF THE INVENTION

Embodiments of the invention relate to dual-mode, adjustable wheel-span vehicles (DMASV) and an associated rail freeway system. As used herein, “dual mode” refers to a vehicle that can run on a regular road and on rails. The term, “adjustable wheel-span” refers to a distance (span) between a pair of wheels on the same axle is adjustable to fit different spans (gauges) of different rail systems. The specially constructed railways with the specially designed on-and-off ramps allow the non-interfering entry and exit of DMASV's, just like the regular cars working with the regular freeways.

As noted above, several different kinds of dual-mode vehicles and the transportation systems have been proposed in the past, but none of them allows incessant accesses, thus are not practical.

Embodiments of the present invention use steel wheels on steel rails, just like the ones used for bullet train systems. Embodiments of the invention also use stereo (3D) structures plus the flexible change of wheel spans to allow vehicles to enter and exit the railways freely without affecting the speeds of the passing vehicles. Embodiments of the invention can meet the high-speed needs, while giving people freedom to drive their own cars on regular roadways or on the specially designed rail freeways.

Embodiments of the invention will be illustrated with the following specific examples. However, one skilled in the art would appreciate that these examples are for illustration only and that other modifications and variations are possible without departing from the scope of the invention.

Vehicle Description

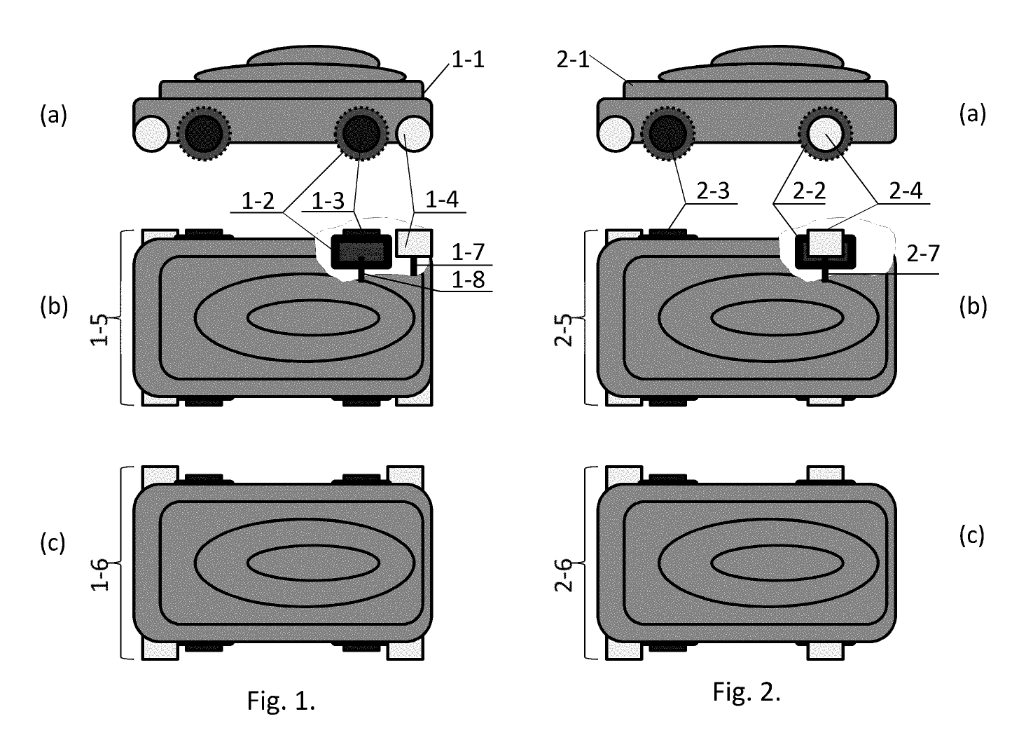

FIG. 1 illustrates an example of a first type (Type A) of dual-mode, adjustable-wheel-span vehicle (DMASV) 1-1, in accordance with embodiments of the invention. As shown in this example, a vehicle has six pairs of wheels 1-2, 1-3, and 1-4. 1-2 are wheels with rubber tires, allowing the vehicles to run on normal roadways (including regular freeways, highways, speedways, roads, and so on). This type of vehicles can be designed with CV joints or flexible axles for front wheel drive. As shown in FIG. 1, smaller wheels 1-3 are mounted on 1-2 (i.e., co-axially). The wheels 1-3 are made of steel (or any suitable material) for running on rails. Their spans are fixed or non-changeable. The other two pairs of smaller wheels 1-4, one pair of which is disposed close to the front end and the other pair is disposed close to the rear end of the vehicle, are steel rail wheels. The spans of these two pairs of rail wheels are adjustable between 1-5 (retracted) and 1-6 (extended) states/positions.

As used in this description, the term “tire wheel” is used to refer to a wheel with tire for regular roadways, which include local streets (paved or unpaved) or highways. A tire wheel has a tire that does not have to be made of rubber. Instead, any suitable materials can be used. The term “rail wheel,” “steel wheel,” or “steel rail wheel” refers to a wheel that is configured to run on a rail system. The term “rail gauge” is used in its customary meaning and refers to the distance between two parallel tracks of a rail system. Rail gauges are usually categorized as standard gauge (used on approximately 54.8% of the world's existing railway lines), broad gauge, and narrow gauge. In accordance with embodiments of the invention, a span (distance) between a pair of rail wheels may be adjustable to fit the rail gauge. As used herein, a pair of rail wheels or a pair of tire wheels refer to two wheels on the same axle.

The materials of these wheel are not important for this invention, and one skilled in the art would appreciate that any suitable material may be used. The term “CV joint” is used to refer to a mechanism that allows a power-driven wheel to be steerable. For clarity of description, the term “CV joint” is used generically in this description to include any similar mechanisms that can perform such similar functions.

In accordance with some embodiments of the invention, the rail wheels and the tire wheels may be arranged to share the same axle, i.e., co-axle or co-axial or co-axially. Some of these embodiments are illustrated later in the examples.

In this figure group, FIG. 1 (a) shows the side view of the vehicle. FIG. 1(b) gives the vehicle's top view with the adjustable rail wheels being set at their retracted positions 1-5, while FIG. 1(c) shows the same view except that the adjustable rail wheels are set at their extended positions 1-6.

The black bar 1-7 in the cut-away view of FIG. 1(b) represents the axle of the adjustable rail wheels. The other black bar 1-8 illustrates the axle for the pair of rear tire wheels 1-2 and the pair of fixed rear rail wheels 1-3.

FIG. 2 shows an example of a second type (Type B) of DMASV 2-1. This type only has 5 pairs of wheels, including two pairs of larger tire wheels 2-2, one pair of fixed rail wheel 2-3, and two pairs of adjustable rail wheels 2-4. The rear pair of fixed rail wheels of Type A vehicles 1-3 is merged with or replaced by the rear pair of adjustable rail wheels 1-4 to form a new pair of adjustable rail wheels 2-4 inside of the rear tire wheels 2-2.

Again, FIG. 2 (a) shows the side view of a Type B vehicle. FIG. 2(b) is its top view with the adjustable wheel pairs retracted 2-5, and FIG. 2(c) show the same except that the adjustable wheel pairs are extended 2-6.

Type B vehicles can also be driven by front tire wheels 2-2 when running on normal roadways. The rear wheel axle 2-7, shown in the cut view of FIG. 2(b) is shared by a pair of tire wheels 2-2 and a pair of adjustable rail wheels 2-4. Its design is relatively complex and will be explained later in this description (See FIG. 11).

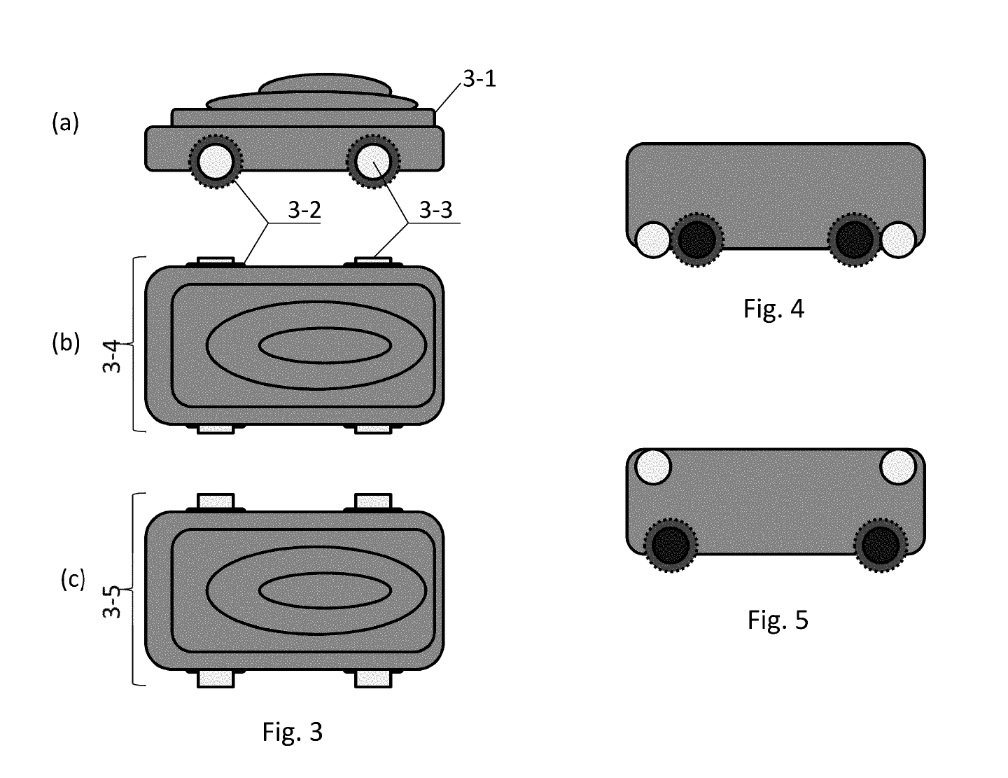

A third type (Type C) of DMASV 3-1 is shown in FIG. 3. It has only 4 pairs of wheels. Two of them are tire wheel pairs 3-2 for regular roadways. The other two pairs are adjustable-span rail wheel pairs 3-3. All of these rail wheels 3-3 are inserted in the tire wheels 3-2. Again, FIG. 3(a) is the side view; FIGS. 3(b) and (c) are the top views with the adjustable rail wheels retracted 3-4 and extended 3-5, respectively.

This type of vehicles has the advantages of lower weight and more compact profile. However, the vehicles preferably are rear-wheel driven, because it is more difficult to design a vehicle that uses CV axles for front-wheel drive concurrently with the inserted rail wheels being adjustable for desired spans. Details will be discussed later in this description (See FIG. 11).

A fourth type of DMAS (Type D) is shown in FIG. 4. It is very similar to Type A except that the body takes the shapes of buses. It can be used for transporting more people in this rail freeway system. Since the system is designed for energy efficiency, environmental preservation and money saving, the vehicles may not be wider than the room for two normal adults sitting shoulder to shoulder.

FIG. 5 Illustrates a variation of Type D vehicles (Type E). This type of vehicles needs the rails at the entry and exit ramps to be elevated. It has the advantage of stability at the ramps, but only works with overhead ramps.

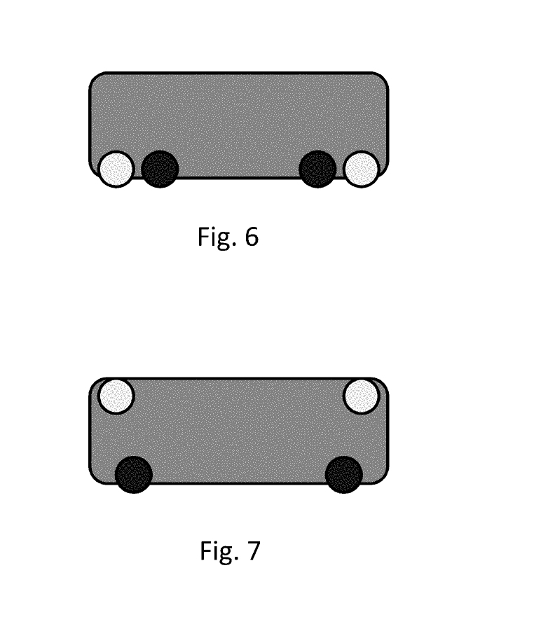

Eliminating the two pairs of tire wheels in Type D vehicles (FIG. 4) and Type E vehicles (FIG. 5) gives two new types of vehicles that work on rails only (Type F in FIG. 6 and Type G in FIG. 7.) Both are useful for passenger loading and unloading of bullet trains without stopping the trains. Type F vehicles are usable for both underneath and overhead ramps, while Type G vehicles can only be used with overhead ramps. These would be explained later in this description.

Similarly, eliminating the fixed rail wheels in vehicles Type A, B, D and F can create four new types of vehicles. They can be called Types A′, B′, D′ and E′ vehicles. The elimination will not affect their regular operations on the new rail freeway system and, therefore, they are part of this invention. However, vehicles with the fixed rail wheels are expected to run more stably.

### Overhead Ramps

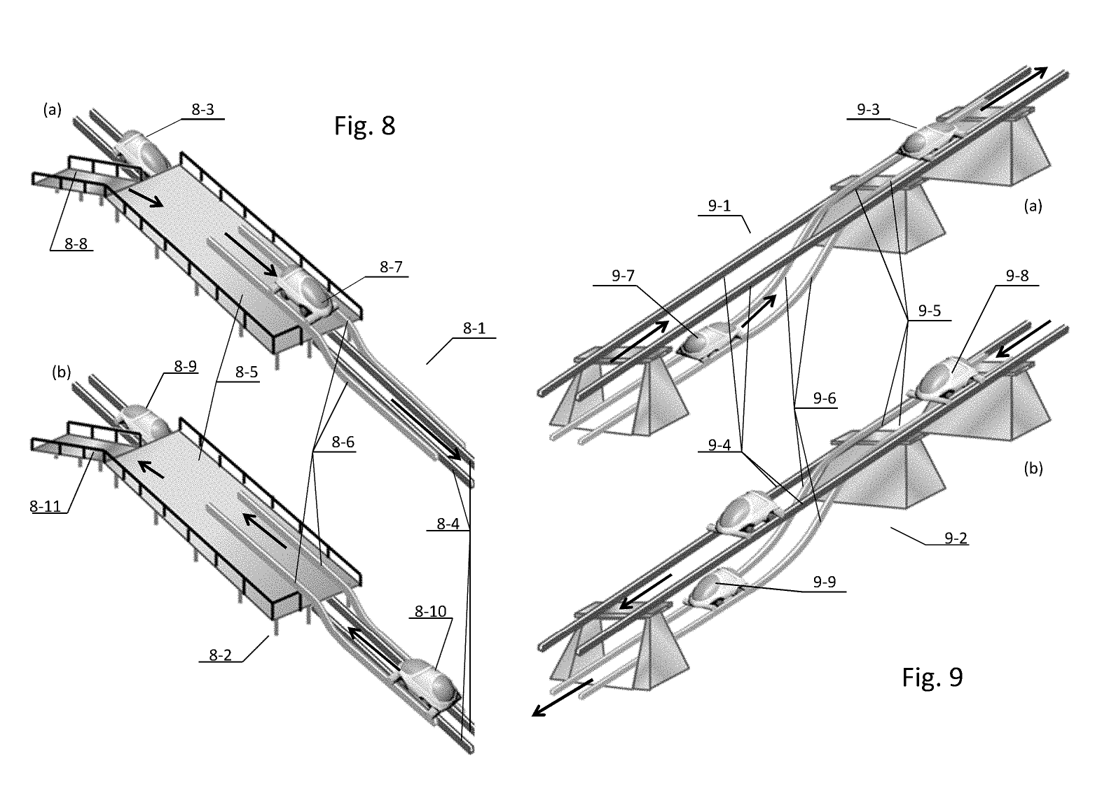

FIGS. 8 (a) and (b) show an overhead entry ramp 8-1 and an exit ramp 8-2. They have the same structure except the traffic flows in the opposite directions. At the entry ramp 8-1 shown by FIG. 8(a), the passing vehicle 8-3 runs along the main rail pair 8-4 under the ramp platform 8-5 and between the ramp rails 8-6. The entering vehicle 8-7 first gets up the platform ramp 8-8, turns straight to the start point of the ramp rails 8-6 on the platform 8-5, gets on the rails with their adjustable rail wheels 1-4 extended to their large span 1-6 as shown in FIG. 1 (c), then runs down the ramp rails 8-6 to merge onto the inner rails 8-4. As soon as the vehicle's fixed rail wheels 1-3 in FIG. 1(a) touch the main rails, the adjustable rail wheels 1-4 can be retrieved.

At the overhead exit ramp 8-2 illustrated by FIG. 8(b), the passing vehicle 8-9 runs along the main rail pair 8-4 under the ramp platform 8-5 and between the ramp rails 8-6. The exiting vehicle 8-10 first extends out its adjustable wheels 1-4 to span 1-6 before entering the exit ramp 8-6. At the ramp, the adjustable wheels 1-4 meet with the gradual rising section of the exit ramp rail 8-6. This smoothly raises the exiting vehicle 8-10 and lets it exit onto the ramp platform 8-5. Then the vehicle 8-10 makes a slight turn to leave the platform 8-5 down through the platform ramp 8-11. As soon as the vehicle leaves the ramp rails, the exiting vehicle 8-10 may retrieve its adjustable rail wheels.

### Underneath Ramps

FIGS. 9 (a) and (b) illustrate the underneath entry ramp 9-1 and exit ramp 9-2. They have the same structure except the traffic flows in the opposite directions. At the entry ramp 9-1 given by FIG. 9(a), the passing vehicle 9-3 runs along the outer (or main) rail pair 9-4. The inner rails 9-5 are cut off to give space for the entering vehicle 9-7 to get on the main rails 9-4 using the sloped section of the ramp rails 9-6. Before coming to the beginning of the ramp rails 9-6 from a regular roadway or freeway feeders, the entering vehicle 9-7 should be at its retracted state, i.e. the spans of the adjustable rail wheels should be reduced to their minimum 1-5 as shown in FIG. 1 (b). After running up the sloped section of the ramp rails 9-6, the vehicle smoothly reaches the level of the passing traffic. At this point the vehicle may expand its adjustable rail wheels or keep its retracted state until the next ramp. This state is determined by the status of the outer rails and inner rails. Detailed discussions of this will be given in the System Design section later in this description.

At the exit ramp 9-2 illustrated by FIG. 9(b), the passing vehicle 9-8 runs along the outer (main) rail pair 9-4. The inner rails 9-5 are cut to allow the exiting vehicle 9-9 to go down through the opening. Before that, the exiting vehicle should be at its retracted state, i.e. the spans of its adjustable wheel pairs should be at their minimum 1-5. At the tips of the exit ramp rails 9-6, the exiting vehicle 9-9 should be slowed down so that the vehicle will not experience a shake when the tire wheels touch the ground.

### Ground-to-Rail and Rail-to-Ground Transitions

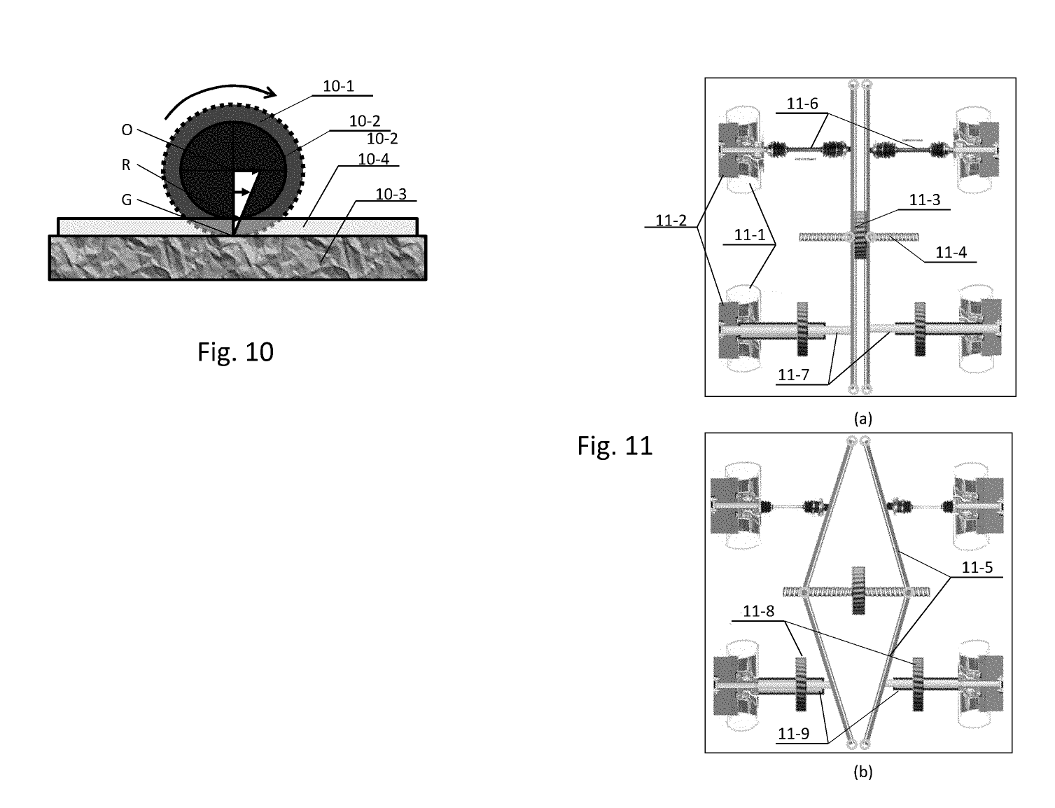

FIG. 10 illustrates a rubber tire wheel 10-1 with a rail wheel 10-2 mounted on it. When the rubber tire wheel 10-1 is running on the ground 10-3, the wheel center O has a horizontal velocity. At Point G where the rubber tire wheel touches the ground, the velocity is zero. At point R where the rail wheel 10-2 touches the rail 10-4, the rail wheel 10-2 also has a horizontal velocity, though it is smaller than the one at Point O. Since at Point R the rail 10-4 is motionless and the rail wheel 10-2 has a velocity, there must be a relative motion between the two objects at the point. The higher the vehicle speed, the higher the relative motion at Point R. This relative motion between two steel bodies may cause sparks or even severe accidents and should be avoided.

The easiest method to solve this problem is to let the vehicles get on and off the rails at low speeds. In practice, however, rubber tire wheels may be preferred to shorten the acceleration or deceleration period. In such cases, the transition between running on rubber tire wheels and steel rail wheels must occur at high speed.

Another method to solve the problem is to use some special materials on the ramp rails so that the slip between the rail wheels and the rails can be eliminated or reduced. Thus, the acceleration or deceleration can take place on the rails and the vehicle can get on or off the rail at the ends with very slow speeds.

The severity of this problem depends on the situation. For overhead ramps with vehicles of which the fixed rail wheels and adjustable rail wheels are separated (Types A, D, F), this is not a problem because the tire wheels and the adjustable rail wheels running on the ramp rails do not use the same axle, therefore, they can have different rotation speeds (See FIGS. 1, 4, 5). In these cases, a differential gear box may be needed to allow different wheels driven at different rotation speeds.

For vehicle Types B and C (See FIGS. 2 and 3), and for underneath ramps of which the ramp rails are the inner rails, at least one pair of rail wheels (fixed or adjustable) runs together with the tire wheels. In these cases, relative motions of two steel bodies cannot be avoided, unless special facilities are designed and applied to counterbalance the relative motions. Such devices can be sliding rails for entryways and sliding floors for exits. Both sliding devices should have certain resistance and can resume quickly to their original state after the vehicles pass through the transition point. Another solution is to use a one-way rotation bearing on the relevant wheels to achieve different rotation speeds. Yet another alternative is to have a clutch mechanism similar to a manual shift car, wherein the clutch is used to engage or disengage a friction connection mechanism linking the wheels and the axles.

In summary, the problem of relative motion should not be a big issue for the present invention.

### Concurrent Expansion and Retraction of Adjustable Rail Wheels

For this newly-invented transportation system to work safely, the vehicles should preferably be able to extend and retract their adjustable rail wheels to the desired spans concurrently and swiftly. Otherwise, accidents may occur. There are many ways to achieve this. FIG. 11 shows a mechanical way for a Type C vehicle as given in FIG. 3. The vehicle has two pairs of rubber tire wheels 11-1 and two pairs of adjustable rail wheels 11-2. FIG. 11 (a) is at the retracted state and FIG. 11 (b) is at the extended state. By turning the gear 11-3 in the center with the thread axle 11-4, the levers 11-5 can be moved out or in concurrently with the same extent. The 4 levers 11-5 further move the CV axles 11-6 for the front wheels and the regular axles 11-7 for the rear wheels. Because these axles 11-6 and 11-7 are attached with the adjustable rail wheels, the motions of these axles 11-6 and 11-7 slide the adjustable rail wheels out or in as desired. Therefore, different spans of the adjustable wheels 11-2 are achieved. Another role of the CV axles is for the vehicle steering when it runs on regular roadways. The vehicle depicted in FIG. 11 is preferably driven by real wheels through the power gears 11-8 and the sleeve axles 11-9. When the CV axles are used for rail wheel span adjustments, it's more difficult to use them for power transmission. Therefore, the vehicle is driven by rear wheels. More complicated design is needed to have this kind of vehicles be driven by front wheels.

The above description is an example for illustration only. One skilled in the art would appreciate that other modifications and variations are possible without departing from the scope of the invention.

The mechanism for the rear wheel shown in FIG. 11 can also be used for the rear wheels of Type B vehicle as shown in FIG. 2.

The span changes of these adjustable wheels can also be done by using a combination of chains and gears, or by using other mechanisms such as pneumatic, hydraulic or electro-magnetic methods.

System Designs

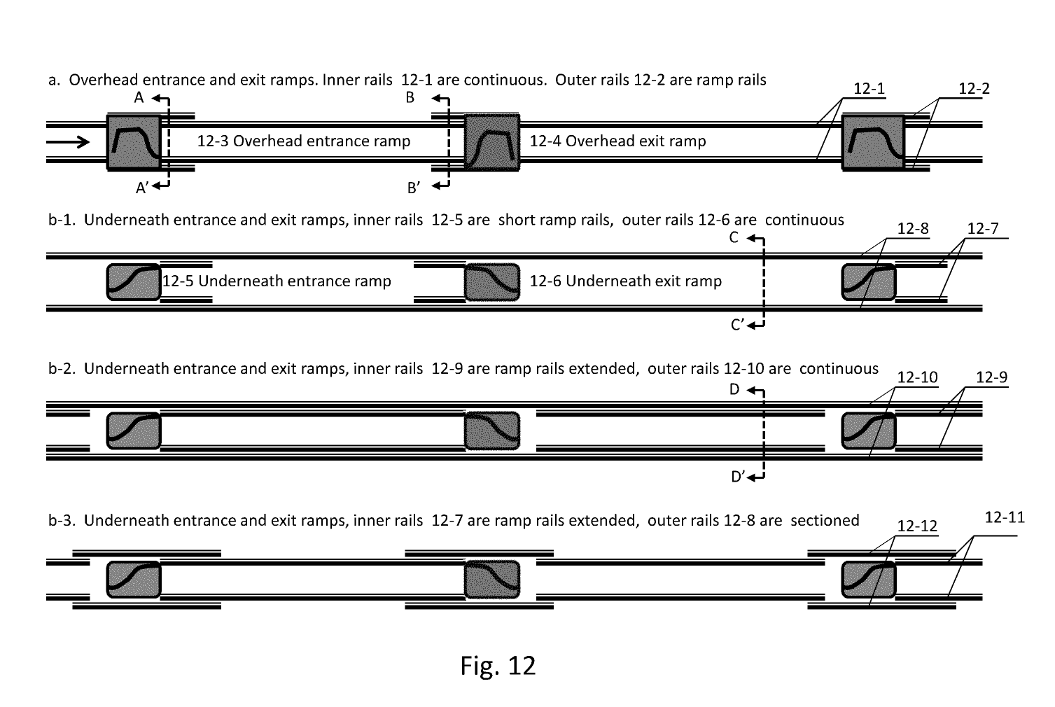

FIG. 12 show the options for rail track designs in relation with entry and exit ramps. FIG. 12 (a) shows a rail layout for a system with overhead ramps. The inner rails 12-1 are continuous and the outer rails 12-2 are the ramp rails at the entry and exit ramps 12-3 and 12-4. In this case, the rails for passing traffic are continuous with smaller span. If vehicles with fixed rail wheels are used, the smaller span and fixed rail wheels make the vehicle axles work at their mechanically favorable states. The continuous rails make it possible for the vehicles to reach high speeds. One possible drawback with this design is that the overhead ramps may need more space and cost more money to build. Another possible drawback is that the vehicles use their adjustable wheels at a large span on the ramp rails. This is mechanically unfavorable for their axles. For these reasons, this type of rail and ramp design may be suitable for intercity long-distance travels, where the number of entry and exit ramps can be reduced. In addition, there can be plenty of spaces to build longer ramps so that the acceleration and deceleration, also the extra loads caused by them, can be significantly reduced. More discussions on this issue are given in the safety section of this document.

FIG. 12 (b-1) shows a rail layout for a system with underneath ramps 12-5 and 12-6. In this case, the inner rails 12-7 are non-continuous ramp rails. The outer rails 12-8 are continuous. When a vehicle enters the entry ramp, the wheels are at the retracted state. As soon as it gets onto the rails, the adjustable wheels can be extended. Although this may not pose any danger with enough safety measures, the vehicles cannot use fixed rail wheels to run on the main rails. The vehicles can only use their adjustable wheels at a large span to travel. This is mechanically unfavorable for the vehicles. Therefore, unless the vehicles are designed with high strength, this type of rail system preferably are used for inner city commutes and is not recommended for inter-city travels.

FIG. 12 (b-2) gives the same system as in FIG. 12(b-1) except that the inner rails are extended to the next ramp. In this case, the inner rails 12-9 are non-continuous only at the ramps. The outer rails 12-10 are continuous. This type of setting allows the vehicles to use their fixed rail wheels between ramps. They only need to have their adjustable rail wheels extended when passing the ramps. Because the inner rails are not continuous at the ramps, the travel speeds may not be as high as a bullet train. It is believed that the non-continuity should not be a problem for vehicles to travel at highway or freeway speeds. For this reason, this system is recommended for inner city commutes, though it may need more steel to build.

FIG. 12 (b-3) shows a similar system with underneath ramps. While the inner rails 12-11 are still extended to each ramp like in FIG. 12 (b-2), the outer rails 12-12 only exist at the ramps. In this case, the vehicles can still run with their adjustable rail wheels extended after getting on the rail system, the sectioned outer and inner rails may further limit the speeds. For this reason, the layout given in FIG. 12 (b-2) is recommended over the one given in FIG. 12 (b-3). Again, tests are needed to verify this speculation.

The above examples illustrate the scenarios, in which the ramps are fixed structures. However, these are for illustration only and other alternatives are possible. For example, one may have moveable track mechanisms at the ramps such that the inner rails and/or the outer rails can become continuous tracks when no vehicle is entering or exiting the system.

### Considerations of System Safety

Safety is the number one parameter to judge if this invention is feasible for public transportation. For this reason, this invention should go through a number of evaluation, design, manufacture, test and inspection for being 100% safe before it gets its permit for public use. This section will discuss some safety-related aspects.

### Can the Vehicles be Safe when the Span of the Rail Wheels is Changed?

To be safe, the vehicle needs to have the abilities to (1) get all its adjustable wheels to their expanded or retracted states concurrently as directed, (2) to keep all wheels on the vehicle even though part of the axle is movable, and (3) to stay strong even when it's at its expanded state. With proper design, these requirements should not be hard to meet. As shown in FIG. 11, the concurrent expansion and retraction can be achieved mechanically. Other devices using pneumatic or hydraulic power should be able to achieve the same. Requirements (2) and (3) depend on specific designs and should not be a big issue for an experienced mechanical engineer. The axle strength and stability of Type C vehicle can be a valid concern because of the flexible feature of the CV axle (11-6 in FIG. 11). When this is the problem, vehicles with stronger designs (Type A and Type B) can always be used.

### Where are the Weak Points on the Proposed Tracks?

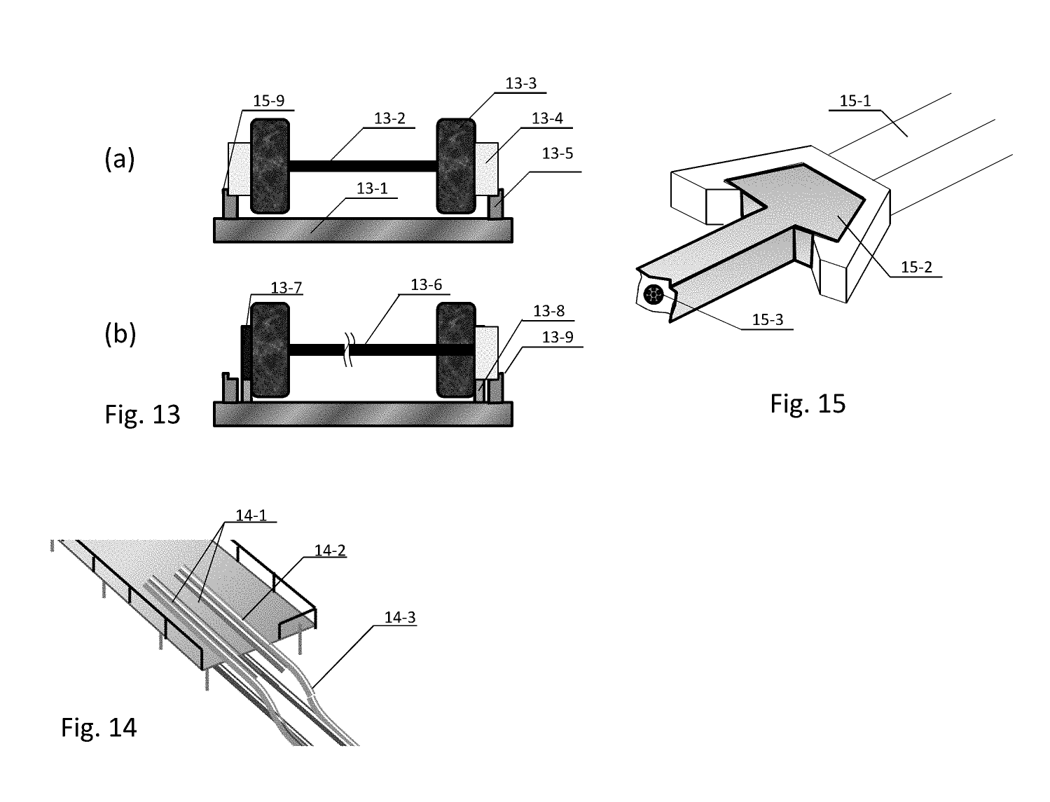

The weak points of a system should be determined by force analysis. In this system, the weak situations occur when (1) the vehicle is at its large span, (2) the adjustable wheels are the only ones that bear the vehicle's load, and (3) the vehicle is applying the maximum load on the rails. In FIG. 12, we found 3 places that meet the first criteria as marked by A-A′, B-B′ and C-C′. The rail-wheel relations are shown in FIG. 13 where 13-1 is the railway base, 13-2 is the axle, 13-3 marks the rubber wheels, 13-4 marks the adjustable rail wheels on tire wheels which correspond with the second criteria, and 13-5 marks the outer rails, which corresponds to the first criteria. Among the 3 places (A-A′, B-B′ and C-C′), A-A′ is the weakest point, because this point not only meets the first two criteria, also satisfies the third one. At this exit ramp, the vehicle needs to use the brake to slow down the vehicle. The deceleration can apply high forces on the ramp rails when it applies the brakes. In contrast, the strongest case is when Type A vehicle running on both inner and out rail pairs at the place marked by D-D′ in FIG. 12 (b-2). Its rail-wheel relations are shown in FIG. 13 (b) in which 13-6 is the axle of the adjustable wheels, 13-7 marks the fixed rail wheels mounted on the tire wheel, and 13-8 marks the inner rails.

As discussed previously, rail freeways with overhead ramps are the top choice for long-distance travelers because the passing rails are continuous inner rails. The vehicles on such railways may reach the speeds of bullet trains. Unfortunately, their entry and exit ramps are the weakest points. Several methods can be used to mitigate the potential risks at these weak points. For weak point C-C′, the type of track can be easily changed to the ones shown in FIGS. 12-(b-2) and (b-3). For the weak points at the overhead ramps marked by A-A′ and B-B′ in FIG. 12 and also in FIGS. 8 (a) and (b), the tracks can be modified as shown in FIG. 14 where a pair of inner rails 14-1 are added in the flat section 14-2. This divides the overhead ramp rails into two sections—the flat section 14-2 on the platform and the curving up section 14-3 where the inner rails must not exist for the passing vehicles to go through the ramp. In practice, the forces applied by the vehicles on the rails can be controlled by reducing the acceleration or deceleration rates in the curving up section 14-3, leaving more acceleration or deceleration in the flat section (14-2). The later may be done more easily using the rubber tires. In addition, extending the flat section can also reduce the acceleration or deceleration rate.

### How to Keep the Vehicles Centralized on the Tracks when the Spans of Adjustable Rail Wheels are Changed Along the Ways?

FIG. 13 can also be used to answer this question. As shown in FIG. 13(b), when the vehicle is running on the inner rails, the tire wheels help centralize the vehicle. When the vehicle is running on the outer rails with the adjustable rail wheels, the shoulder 13-9 on the outer rail keeps the vehicle on track.

### How Will we Get People Off the Road in Cases of Illnesses and Accidents?

In case of an emergency with a driver on board of a vehicle, the system computer may quickly guide the vehicle out of an exit close to a hospital. If the person cannot drive, the system computer may be designed to work with GPS to stop the vehicle at a safe place for ambulance to come.

In case of accidents or stalled vehicles, the rescue crew can use the regular freeway to get accessed to the spot for rescuing. If the traffic on rails is blocked, it can always be diverted to the normal freeways. After passing the problematic spot, the traffic can enter the rail freeway again.

### How to Prevent the Vehicles from Bump into Each Other when they are Either Running, Entering or Exiting?

In fact, the vehicles are designed to allow them to bump into and connect with each other. FIG. 15 illustrates the hook-up device that can chain two adjacent vehicles together and make them act like a train. In this figure, 15-1 is the rear end of leading vehicle and 15-2 is the front end of the trailing vehicle. The vehicles should be able to chain up while running. The device should have springs or other cushion to absorb the possible impact during the hook-up. In the center of the hook-up, there is a wire connector that allows instantaneous communication for the vehicle chain while running. If a vehicle in the chain needs to exit, the device should be able to disconnect momentarily and the vehicle behind the connecting device should be controlled by the computer on board with the messages from the vehicle's sensors. The computer on board should also be able to get information from the ramps that tells weather it is safe or if there is enough room for the vehicle to exit at the ramp. For the entering vehicles, the system computer should have a timing control that allows the vehicle to enter the system behind the chains of vehicles.

### What if the Rail Freeway is Hit and Damaged by Vehicles Running on the Highway?

This is one of the main challenges for this system if the railways are built along the highways. The rail freeways must be built strong enough to stand the vehicle hit. Protective walls must be built along the rail freeways. For places with high accident occurrence, the rail freeways should be built at a distance away from the roadways.

### Will Bad Weather Affect the Operation of the Rail Freeway System?

Although the vehicles are supposed to be lighter than regular cars, they should be heavy and sturdy enough to run regularly in bad weather. In extremely bad weather, such as hurricanes, tornados and icy rails, the system may be warned to slow down. In fact, special devices may be installed on vehicles that can hold the vehicles on rails during this type of bad weather. From this sense, travel with the rail freeway system should be much safer and more timely-reliable than travel with the airways and highways.

### Since the DMASV's are Supposed to be Light and Small, is it Safe for them to Run on Regular Roadways?

This purely depends on the design of these vehicles. It is expected that passengers should have several layers of protection. First, the vehicle frame should have the necessary springs or cushion type devices to absorb the impact during an accident. Second, the vehicle should have two main portions. One is the frame with battery, gear boxes, and so on, and the other portion is the passenger cabin with the computer and controls. If the hit is too hard, the cabin with passengers should be sprung away from the crash point. Third, while the frame acts like a spring, the cabin frame should be strong enough to stand the hardest crash in the highway. Fourth, air bags should be installed in all directions around the passengers. Finally, the airbags can act like a floatation device, protecting the passengers crashing into water.

### Is there a Computerized Control System for Safety?

To promote system safety, continuous sensing is needed all the time to give instantaneous messages for system computers and on-board computers to take the right actions instantaneously. This kind of sensing should include remote operation to see or feel approaching or leaving vehicles at certain distances. Angled sensing at the entries and exits is especially needed to avoid collapses of nearby vehicles. Sensing is also needed to judge when to let the vehicles at the entries to start running. Some sensors are on the vehicles, while some other sensors should be mounted at the entries and exits.

The system computers, as the central brains of all vehicles in the system, should be able to get all information from all sensors and on-board computers and send out all commands for all vehicles to take the necessary actions. This type of systematic interactions is especially needed for vehicles to run as a chain on rails. In case of certain kind of emergency, the system computer should be able to send a single braking signal to all approaching vehicles, either in the same chain or in the chains nearby.

Besides this kind of systematic control, individual vehicle should have an independent sensing, judging and braking system to take the necessary safety measures during an emergency. This safety feature serves as the second layer of protection for the passenger and the system.

Because the vehicle is auto controlled when running on rail freeways, an auto alarm system, either by sounds or by physical shaking, is needed to wake up sleeping drivers.

The control system should also consider the possibility of the unexpected loss of drivers' ability to drive. In such situations, whether by sensors or being messaged, the system computers should be able to work with the on-board computer or even GPS to guide the vehicle out of the railways at the proper exit.

### Extension of Overhead Ramps for Non-Stop Bullet Train System

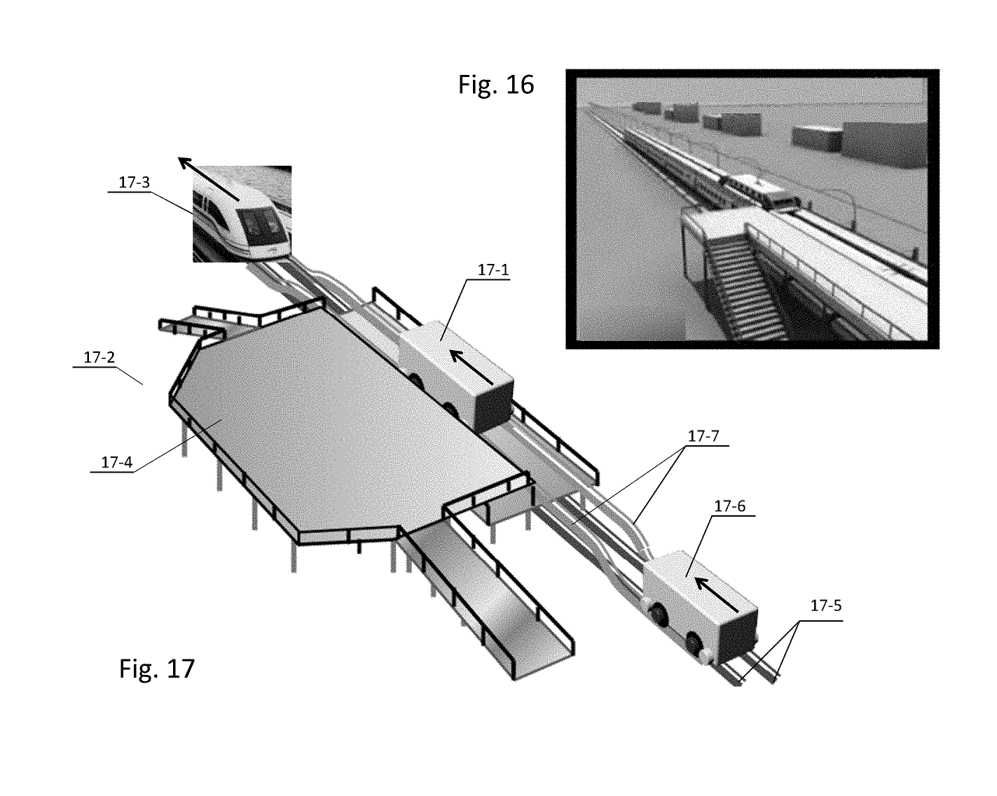

In 2010, an interesting idea of non-stop bullet train system was proposed in China. The idea is to have the bullet train carry a passenger cabin on its top (FIG. 16). At the stations, the overhead passenger cabin with arriving passengers lands on the station's platform for passenger unloading. Meanwhile, bullet train takes away another passenger cabin that was previously loaded with leaving passengers.

While this idea is quite interesting, it may not be practical. First, the overhead cabin raises the train's center of mass, which makes the train more unstable, especially at turns. Second, with the overhead cabin, the bullet train may not be able to go through tunnels and other built-in facilities along the railway that have limited space overhead. For these reasons, six years have passed and no one has ever built such a non-stop train system.

By combining the designs of our overhead entry ramp and overhead exit ramp (FIG. 8), this invention can be extended to form a passenger loading and unloading system for non-stop bullet trains (See FIG. 17). In this system, a rail-bus 17-1 on the station 17-2 is preloaded with leaving passengers. The bullet train 17-3 goes under the platform 17-4 using the inner rails 17-5. The train brings a rail-bus 17-6 with arriving passengers. When the train 17-3 approaches the station 17-2, the adjustable rail wheels on the rail-bus 17-6 extend and touch the outer ramp rails 17-7. The rising of rail-bus 17-6 along the ramp rails detaches itself from the train 17-3, leading the bus up the ramp rails to land on the platform 17-4. At the same time, the preloaded rail-bus 17-1 started to run down the ramp and catch up the train 17-3 for passenger rotation.

In this process, the fixed and adjustable rail wheels on a rail-bus work just like these wheels on DMASV's exiting and then entering the rail freeways. Since the rail bus is behind the regular train, it does not need any extra overhead room to operate. The only things that need to be built are the stations for rail buses to take off and land on.

### Other Considerations

### System Power Supply

All vehicles in this system are intended to be electrically powered with a battery on board. The battery provides power for vehicles to run on regular roadways. When these vehicles run on rail freeways, they should use the power from the power line, just like the way a bullet train does. Meanwhile, their batteries should get charged.

Solar panels can be installed on top of the rail freeways to provide the power whenever possible.

### Lane Shifting

When traffic on the system becomes heavy, more tracks can be built. The vehicles can get on and off these extra tracks directly from ramps with more openings. It can also be done with overhead shifting ramps and underneath shifting ramps. The overhead shifting ramp looks just like the system for non-stop bullet trains (FIG. 17). The only difference is that it has a horizontal curving section for lane shifting. The underneath shifting ramp can be formed by combing FIGS. 9 (a) and (b) with a horizontal curve section.

### Ramps for Vehicles Type E and G

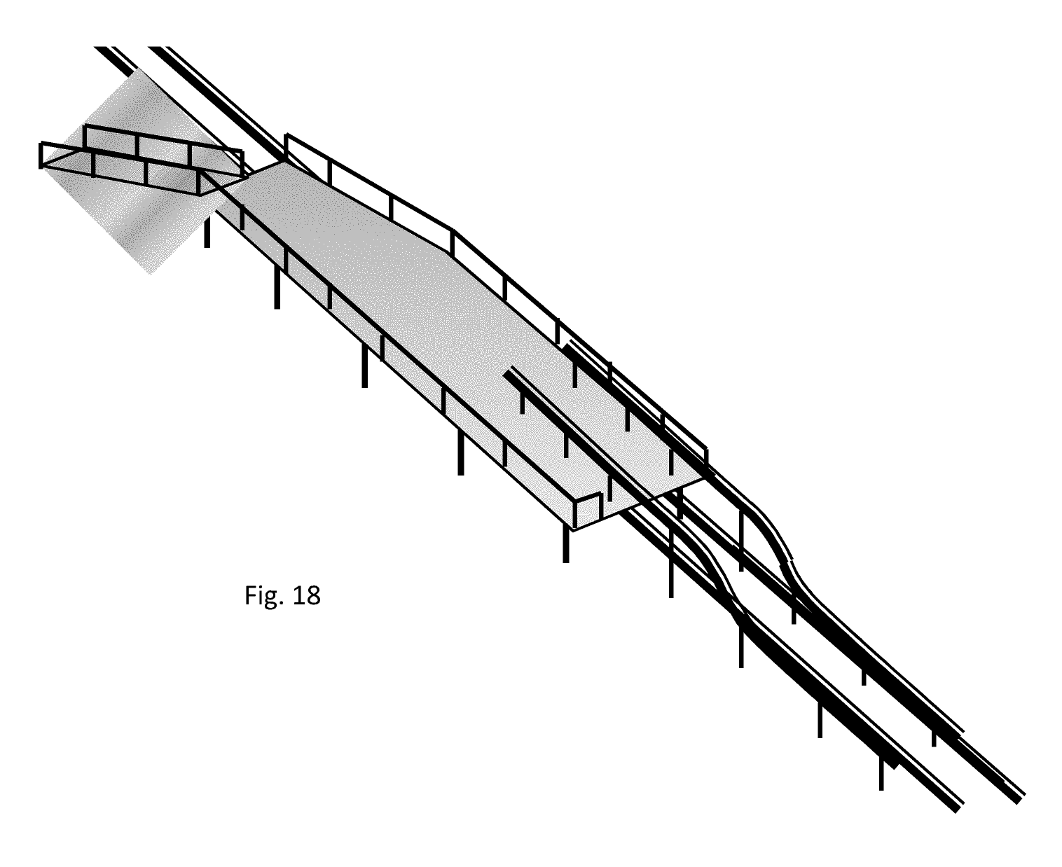

As shown in FIG. 5, the adjustable rail wheels of Type E vehicle are not in the same level as the fixed rails. For this type of vehicles to work, rails for the adjustable rail wheels must be elevated. FIG. 18 shows a ramp for this type of vehicles. Obviously, the rail systems for this type of vehicles are hard and costly to build. Hence, this type of vehicles and their rail systems are not recommended.

However, a similar vehicle for non-stop bullet trains, Type G as shown in FIG. 7, may have its applicability. With its adjustable rail wheels at the top, the vehicle may be more stable when running up and down the ramps.

### Additional Applications

With proper design and testing, the system may be used for driverless, long-distance transportation of goods, children, elders or even patients. In these applications, the vehicle may just be an electric motor trailer without the capability of steering and power storage. The trailer can be rented and hauled home. After being loaded with what to be sent with, the trailer can be hauled to a special station for dispatching. The station acts just like a dock for a boat. The trailer is then guided by system computer to a similar station near its destination. There it can be pulled away by regular cars to its destination.

### Preliminary Evaluation of the Rail Freeway System and its Advantages Over Bullet Trains

Previous sections in this description discusses the status of world transportation and the need for a more effective transportation method, as well as the details of our invention. Based on these discussions, the newly invented rail freeway system of the invention may have one or more of the following advantages.

It is socially enviable. As mentioned earlier in the background section, traffic jams have been acting just like artery clogs for all grown or fast-growing countries. It causes people remarkable car-wearing and gas burning, costs people significant amount of time and money, adds extra stress and trouble to people's daily life and deteriorates people's health. This new rail freeway system can be used to solve the traffic jam problem, therefore, is highly desired.

It is technically feasible. As discussed in the detailed description section, the new system can be used for both inner-city daily commutes and inter-city travels. The rail freeways with overhead ramps are best for intercity travels because the inner rails are main rails which are continuous all along the way. This continuous, inner-rail feature makes it possible for the vehicles to gain speeds as high as bullet trains. The rail freeways with underneath ramps are best used for daily commutes. Because of the frequent entering and exiting of highways, the rail freeways must be elevated. It's convenient to build ramps under the main freeways. These two types of ramps make the free entering and exiting of rail freeways possible.

It is favorable. Since the new system lets people keep their own privacy, enjoy their own freedom and control their own pace in their trips or commutes, it should be highly appreciable by everyone troubled by traffic jams. Because it has the ability to divert a substantial portion of traffic from the main roadways, it has the potential to completely resolve the traffic jams problems in most major cities in the world. This helps reduce gas burning and car wearing, alleviate air pollution, save people time and money, ease people's living stress, improve people's health and increase people's work efficiency.

It is economically viable. Because almost all vehicles are individually owned, the system does not need to include the cost for vehicles, the salary for attendants, the fee for maintenance and the expenses for repairing. Because it is to be built on governmental lands along major highways and streets, the cost for lands can be eliminated. Because the system is for light transportation, the vehicles and tracks can be narrower than regular bullet trains. Therefore, the costs for building this newly invented system (labors and materials) can be significantly lower than bullet trains. Table 1 lists the economic advantages of rail freeway system over bullet trains.

TABLE 1
Cost Comparison between Bullet Train System and Rail Freeway System

| Items | Bullet Train System | Rail Freeway System |
|---|---|---|
| Railways construction | Heavy so more expensive | Light so cheaper |
| Stations | Need significant amount of money to build | No need |
| Parking | Need large parking land and and be costly | No need |
| | to system and travelers | |
| Cars | Huge so expensive to build and maintain | Small and privately owned, no cost |
| | | for the system |
| Land | Need vast acres of land so a large amount | Can just use the sides of existing |
| | money | highways. No land cost |
| Control system and | Intensively needed | Intensively needed and can be |
| signals | | combined with personal operations |
| Track Maintenance | High because the tracks are hard to access | Low because the tracks are easy to |
| | | access |
| Administration | Need all kind of attendant services | All services become personal matters |

In short, with all these savings, the rail freeway system may just be ⅓ or even ¼ of the cost for a regular bullet train system.

It's operationally profitable. As listed in Table 2, the new system can have a large number of advantages over a bullet train system, such as the privacy, freedom, convenience, low stress, and so on. These will give the users more incentive to use the system. The more people use it, the more profitable the system can be.

TABLE 2
Comparison between Bullet Train System and Rail Freeway System

| Items | Bullet Train System | Rail Freeway System |
|---|---|---|
| Privacy | No. It takes the car + Mass Vehicle + Car model | Yes |
| Freedom | No. It takes the car + Mass Vehicle + Car model | Yes |
| Convenient | No. It takes the car + Mass Vehicle + Car model | Yes |
| Stress | Low on train but high on catching up on | Low with auto control systems |
| | schedules, and long waiting period | |
| Terrorism | Larger concern | Smaller concern |
| Environments | Friendly | Friendly. May be built with solar panel. When being applied in |
| | | cities, it can significantly reduce the transit time for all. Burn |
| | | less gases and lead to low polution |
| Savings | Expensive due to all the extra costs, such as | Save gas due to fast transit, no parking fee, no need of extra |
| | food, parking, and so on | food due to less waiting time, and so on |
| Emergency | Very hard to get everyone off | Can exit at the same place of the highways. With extra |
| | | measures and tools, traincars can get off the tracks at even |
| Safety | Improving | Can be built with higher safety measures |
| Speed | >200 MPH | >200 MPH |

Overall, the newly invented system has a significant number of advantages over the bullet train system and can be economically built and successfully operated.

Embodiments of the invention have been illustrated with a limited number of examples. One skilled in the art would appreciate that other modifications and variations are possible without departing from the scope of the invention. Therefore, the scope of the invention should be limited by the accompanying claims.

What is claimed is:

1. A dual-mode, adjustable wheel-span vehicle, comprising:
at least two pairs of rail wheels for use on rails, wherein some or all of the at least two pairs of rail wheels are adjustable in a distance between a pair of the rail wheels such that the at least two pairs of rail wheels can work with different rail gauges;
a mechanism for adjusting a span of the at least two pairs of rail wheels; and
at least two pairs of tire wheels for regular roadways.

2. The dual-mode, adjustable wheel-span vehicle according to claim 1, wherein some or all of the at least two pairs of rail wheels are configured to be co-axle with the at least two pairs of tire wheels.

3. The dual-mode, adjustable wheel-span vehicle according to claim 1, wherein some of the at least two pairs of rail wheels are non-adjustable and have a fixed distance between a pair of rail wheels.

4. The dual-mode, adjustable wheel-span vehicle according to claim 3, wherein the rail wheels that are non-adjustable are configured to share a same axle with a pair of the at least two pairs of tire wheels.

5. The dual-mode, adjustable wheel-span vehicle according to claim 4, wherein the rail wheels, which share the same axle with the pair of the tire wheels, have a smaller diameter than that of the tire wheels sharing the same axle.

6. The dual-mode, adjustable wheel-span vehicle according to claim 1, wherein a first pair of rail wheels and a first pair of tire wheels are arranged at a front portion of the vehicle, and a second pair of rail wheels and a second pair of tire wheels are arranged at a rear portion of the vehicle.

7. The dual-mode, adjustable wheel-span vehicle according to claim 1, wherein the first pair of rail wheels and the first pair of tire wheels are arranged co-axially, and/or the second pair of rail wheels and the second pair of tire wheels are arranged co-axially.

8. The dual-mode, adjustable wheel-span vehicle according to claim 7, further comprising a pair of adjustable wheel-span rail wheels arranged on a top portion of the vehicle.

9. The dual-mode, adjustable wheel-span vehicle according to claim 1, wherein the mechanism for adjusting the span of the at least two pairs of rail wheels comprises:
a pair of connecting rods having a same length, each of the connecting rods has a first end fixedly attached to vehicle and a second end having a screw hole for connection with a screw shafts, and at substantially the same positions of said pair of said links Connect a pair of axles connected, respectively, at middle sections of the pair of the connecting rods;
both ends of the screw shaft, respectively, passing through the threaded holes at the second end of the pair of the connecting rods; and
a gear disposed between the pair of the connecting rods and fixedly secured to said screw shaft,
wherein the screw shaft having screw threads in opposite directions on both halves of the screw shaft such that when the gear drives the screw shaft the second ends of the connecting rods are pulled closer or pushed farther apart depending on a rotation of the gear, thereby moving the pair of axles to change a wheel pitch.

10. A transportation system for a plurality of the dual-mode, adjustable-span vehicles according to claim 1, comprising:
a rail freeway network comprising electric power supply lines to provide power, sensors to get local information, signals to show system status, and a central computer for system controls; and
a plurality of entry and exit ramps for the plurality of the dual-mode, adjustable-span vehicles to enter or exit the rail freeway network, wherein the entry and exit ramps comprise an overhead and/or underneath ramp.

11. The transportation system according to claim 10, wherein the overhead ramp is disposed above a main rail system of the rail freeway network and the overhead ramp comprises a pair of ramp rails that have a span larger than a span of the main rail system such that the pair of the ramp rails are arranged outside the main rail system.

12. The transportation system according to claim 10, wherein the underneath ramp is disposed below a main rail system of the rail freeway network and the underneath ramp comprises a pair of ramp rails that have a span smaller than a span of the main rail system such that the pair of the ramp rails are arranged inside the main rail system.
